(19) United States
(12) Patent Application Publication
(10) Pub. No.: US 2007/0065269 A1
(43) Pub. Date: Mar. 22, 2007

(54) Pallet for coiled carrying article, loading structure for loading coiled carrying article on pallet, stacking structure for stacking carrying article loading pallets and method for using the same, containing structure for containing stacked coiled carrying article loading pallets into transport receptacle and transport method therefor, and coiled carrying article transport method

(76) Inventors: Tatsuhiko Aoki, Aichi (JP); Nobuaki Itou, Aichi (JP); Nobuhiro Kato, Aichi (JP)

Correspondence Address: MORGAN LEWIS & BOCKIUS LLP, 1111 PENNSYLVANIA AVENUE NW, WASHINGTON, DC, 20004, US

(21) Appl. No.: 10/544,505

(22) PCT Filed: Feb. 7, 2003
(86) PCT No.: PCT/JP03/01296

§ 371 Date: Sep. 1, 2006

(51) Int. Cl. B65G 57/16

(52) U.S. Cl. 414/788.2

(57) ABSTRACT

This invention intends to provide a coiled carrying article pallet, which is suited for transporting small quantities of varied types of articles, which can easily, deliberately, efficiently transporting a coiled carrying article to a transport receptacle without damaging the coiled transport article, which can transport the coiled carrying article with transport cost being held down, and which can improve space efficiency for storage, and the like. The pallet P1 is a coiled carrying article pallet P1 contained in a transport receptacle (container A) while loading the coiled carrying article C, the pallet P1 including a pallet main body 1, and a stack support means 5, provided on the pallet main body, for vertically stacking and supporting another pallet P1, and the pallet main body 1 includes a mount section 3 on which the axial end face of the carrying article can be mounted, and an abutment section 2 provided on an outer peripheral side of the mount section and arranging a plurality of carrying articles in a zigzag fashion.

### BACKGROUND OF THE INVENTION

1. Field of the Invention

The present invention relates to a pallet for a coiled carrying article, a loading structure for loading a coiled carrying article to a pallet, a stacking structure for stacking carrying article loading pallets and a method for using the same, a containing structure for containing stacked coiled carrying article loading pallets into a transport receptacle and a transport method therefor, and a coiled carrying article transport method. More specifically, the present invention relates to a pallet for a coiled carrying article, a loading structure for loading a coiled carrying article to a pallet, a stacking structure for stacking carrying article loading pallets and a method for using the same, a containing structure for containing stacked coiled carrying article loading pallets into a transport receptacle and a transport method therefor, and a coiled carrying article transport method which are suited for the transport of a small quantity of varied types articles, which can easily, deliberately, efficiently transport coiled carrying articles into a transport receptacle without damaging the articles, which can transport the coiled carrying articles with transport cost being held down, and which can improve space efficiency for storage.

2. Description of the Related Art

As wire rods which are dealt with in a coiled state (to be referred to as “coiled wire rods” hereinafter), there are known the following two types of wire rods: a wire rod which is made of an ordinary material (e.g., free cutting steel) and which has a weight of about 2t (a maximum outside diameter of about 1200 to 1400 mm, and an axial length of about 1300 mm), and a wire rod which is made of a high-grade material (e.g., stainless steel or aluminum) and which has a weight of about 1t (a maximum outside diameter of about 1200 to 1400, and an axial length of about 650 mm). To transport these coiled wire rods, a forklift, a crane or the like is often used as a transport means.

To transport the above coiled wire rods by marine transport, bulk cargo by using a bulk cargo ship is often employed. If coiled wire rods are transported by this method, the rods are strictly packaged with rust proof sheets or vinyl sheets one by one to prevent the rods from being damaged or rusted and cargo work is conducted for each packaged coiled wire rod.

With the transport method using the bulk cargo ship which handles bulk cargos, however, cargos in large quantities are transported at once, which disadvantageously requires a large space (a warehouse or the like) to temporarily store the large quantities of cargos thus transported. In addition, this method disadvantageously requires labor for, for example, fixing cargos (which labor is referred to as “lashing”) whenever transport means is to be changed. Besides, even if the coiled rods are packaged relatively strictly, they are sometimes damaged.

Considering these disadvantages, there has been proposed container transport as a transport method for transporting coiled wire rods in small quantities (see, for example, Japanese Patent Laid-Open Application Publication No. 11-227677). This container transport has advantages of shortening loading time and a transport period by handling the coiled wire rods for each container, saving a space for storing the coiled wire rods before and after the transport, and the like.

Nevertheless, according to the above-stated container transport, if coiled wire rods are transported into a container by transport means such as a forklift (so-called vanning or de-vanning), the coiled wire rods are sometimes damaged by the pawls of the forklift or by being struck against the inner wall of the container or the floor face thereof. Further, since an operation for sending the coiled wire rods in the container is carried out based on spot articles, all the articles to be transported cannot be sometimes contained in the container.

Moreover, the coiled wire rods contained in the container are put on the container floor while the axial direction of the rods is oriented horizontally (in a so-called Eye-to-Wall state), that is, the peripheral sides of the coiled wire rods are put on the container floor. Due to this, as in the case of the cargo ship transport stated above, it is necessary to strictly package the entire coiled wire rods using a rust proof sheet, a vinyl sheet of the like so as to prevent the coiled wire rods from being damaged or rusted. It is also necessary to fix the coiled wire rods which are contained in the container to the container floor, the inner wall or the like using rope, lumbers or the like so as to prevent the rods from being tumbled down or moved. In addition, the coiled wire rods which are contained in the container are put horizontally and not vertically stacked so as not to be crushed or damaged. These disadvantageously, considerably deteriorate efficiency for loading the coiled wire rods into the container. As for the coiled wire rods made of a high-grade material, in particular, the number of the rods is large as compared with the rods made of an ordinary material and the rods tend to be more damaged. Due to this, the above-stated packaging operation and fixing operation for the coiled wire rods made of a high-grade material become complex and loading efficiency is low compared with those of an ordinary material. These various factors disadvantageously push up the transport cost of the conventional container transport for coiled wire rods.

Land transport by, for example, a truck or a freight car is faced with the same disadvantages as those of the container transport described above.

Moreover, if a coiled carrying article manufacturer, a distribution center, a processing manufacturer or the like stores coiled carrying articles, the coiled carrying articles are disadvantageously damaged and a large storage space is disadvantageously necessary. This is because the articles are directly put on the floor or the like horizontally to the axial direction and the coiled carrying articles are directly stacked to each other. It is substantially impossible to horizontally load stacks of three or more coiled carrying articles made of a high-grade material, in particular, which greatly deteriorates space efficiency for the storage space.

Furthermore, according to the conventional container transport, coiled carrying articles made of an ordinary material and those made of a high-grade material, different in the degree of handling easiness, are not mixed in one container. This disadvantageously makes it impossible to deal with the transport of small quantities of articles of varied types. As a result, the number of stocks of the coiled carrying articles increases in a transport destination, and the transport destination requires a wide storage space.

Additionally, in the coiled wire rod processing manufacturer, a predetermined processing (e.g., drawing) is conducted to wired rods unwound from the coiled wire rods and supported by an unwinding mechanism (which is also referred to as “supply-stand mechanism”). In addition, the coiled carrying articles stored horizontally to the axial direction are positioned to a dedicated pallet (dedicated tool) by transport means (e.g., a forklift) with the same attitude being kept. The coiled carrying articles together with this dedicated pallet are stood up so that the axial direction becomes vertical, and attached to a vertical supporting axis which constitutes the unwinding mechanism. However, if the coiled carrying articles are stood up together with the dedicated pallet, the articles are sometimes damaged.

### SUMMARY OF THE INVENTION

The present invention has been made to solve the above-stated disadvantages. It is an object of the present invention to provide a pallet for coiled carrying articles which is suited for the transport of small quantities of varied types of articles, which can easily, deliberately, efficiently transport the coiled carrying articles into a transport receptacle without damaging the articles, which can transport the coiled carrying articles with transport cost being held down, and which can improve space efficiency for storing the coiled carrying articles. It is another object of the present invention to provide a pallet for coiled carrying articles which can be set to and supported by an unwinding mechanism without damaging the coiled carrying articles.

It is yet another object of the present invention to provide a loading structure for loading coiled carrying articles on a pallet, stacking structure for carrying article loading pallets and a method for using the structure, a containing structure for containing a coiled carrying article loading pallet into a container and a transport method therefor, and a coiled carrying article transport method.

The invention will now be described hereinafter.

[1] A coiled carrying article pallet contained in a transport receptacle while loading a coiled carrying article, the pallet comprising:

a pallet main body;

a stack support means, provided on the pallet main body, for vertically stacking and supporting another pallet;

a mount section provided on said pallet main body, and capable of mounting an axial end face side of said coiled carrying article; and

an abutment section provided on an outer peripheral side of the mount section, wherein

if a plurality of said pallets are contained in said transport receptacle, said abutment sections of the adjacent pallets among the plurality of said pallets abut on each other, whereby a plurality of said coiled carrying articles loaded on the plurality of said pallets are arranged in a zigzag fashion.

[2] A coiled carrying article pallet according to above [1], wherein

a central section insertion space, insertable into a vertical support axis which constitutes an unwinding mechanism for unwinding said coiled carrying article, is formed in a central section of said pallet main body.

[3] A coiled carrying article pallet according to above [1], wherein

said pallet main body includes a leg section provided below the pallet main body, the leg section capable of landing on a floor.

[4] A coiled carrying article pallet according to above [1], wherein a lower insertion space, into which a transport means for floating the pallet main body from a floor and transporting the pallet can be inserted, is formed below said pallet main body.

[5] A coiled carrying article pallet according to above [1], wherein said stack support means includes a protrusion prevention section preventing said coiled carrying article mounted on said mount section from being protruded laterally.

[6] A coiled carrying article pallet according to above [1], wherein said stack support means includes an upper end receiving section and a lower end engagement section, said upper end receiving section of said lower pallet and said lower end engagement section of said upper pallet are engaged with each other, said lower pallet and said upper pallet forming a pair among the plurality of said pallets in stacking the plurality of said pallets.

[7] A coiled carrying article pallet according to above [1], wherein said stack support means consists of a plurality of stack base materials attached to said pallet main body, and extending vertically.

[8] A coiled carrying article pallet according to above [1], wherein said mount section consists of a plurality of mount base materials arranged in a horizontal plane.

[9] A coiled carrying article pallet according to above [1], wherein said abutment section is shaped into a polygonal ring form.

[10] A coiled carrying article pallet according to above [1], wherein said transport receptacle is a container.

[11] A coiled carrying article pallet according to above [1], wherein said coiled carrying article is formed by winding a wire rod or a plate into a coil.

[12] A coiled carrying article pallet according to above [1], wherein a diameter of said coiled carrying article is set larger than half a width of said transport receptacle, and an axial length of the coiled carrying article is set smaller than half a height of said transport receptacle.

[13] A loading structure for loading a coiled carrying article on a pallet, comprising:

the pallet according to above [1]; and

said coiled carrying article loaded on the pallet while an axial direction is oriented to a vertical direction.

[14] A stacking structure for stacking a plurality of carrying article loading pallets, wherein a plurality of the loading structures according to above [13] are stacked vertically.

[15] A containing structure for containing a stack of carrying article loading pallets into a transport receptacle comprising: the transport receptacle; and the stacking structure according to above [14], wherein

a plurality of said coiled carrying articles contained in said transport receptacle are arranged in a zigzag fashion.

[16] A containing structure for containing a stack of carrying article loading pallets into a transport receptacle according to above [15], further comprising a single carrying article loading pallet which is contained in said transport receptacle and on which another pallet is not stacked.

[17] A method for transporting a stack of carrying article loading pallets to a transport receptacle, wherein the stacking structure according to above [14] is transported into said transport receptacle.

[18] A method for transporting a coiled carrying article, comprising:

an introducing step of introducing the stacking structure according to above [14] into said transport receptacle;

a transport step of transporting said transport receptacle containing a predetermined number of said coiled carrying articles in said introducing step to a destination; and

a discharging step of discharging said stacking structure from said transport receptacle transported to the destination in said transport step.

[19] A method for using a carrying article loading pallet, wherein the loading structure according to above [13] is supported by an unwinding mechanism by inserting the loading structure into a vertical support axis constituting the unwinding mechanism from above.

According to the coiled carrying article pallet of the present invention, the coiled carrying article is loaded by the mount section while the axial direction of the article is set vertically (in a so-called “Eye to Sky” state) without protruding the article from the pallet. In addition, a plurality of carrying article loading pallets are vertically stacked and supported by the stack support means and a plurality of coiled carrying articles are vertically stacked. Further, if a plurality of pallets are contained in the transport receptacle, the abutment sections of the adjacent pallets abut on each other. A plurality of coiled carrying articles are thereby arranged in a zigzag fashion if the transport receptacle is seen from a plane.

Since the coiled carrying article can be transported to the transport receptacle through such a pallet, the transport means does not directly contact with the coiled carrying article. In addition, even if a user makes a mistake in measuring the distance with the eye during transport, the abutment section abuts on the inner wall of the transport receptacle, the floor or the like and the coiled carrying article does not directly contact with the inner wall, floor or the like thereof. It is, therefore, possible to easily, deliberately, efficiently transport the coiled carrying article to the transport receptacle without damaging the article. Further, it is unnecessary to strictly package the coiled wire rod, it is possible to minimize an operation for fixing the coiled carrying article in the transport receptacle (which operation is basically unnecessary), and it is also possible to improve efficiency for loading the coiled carrying article on the transport receptacle. As a result, it is possible to transport the coiled carrying articles with transport cost being held down, and to improve space efficiency for the storage of the coiled carrying articles.

If the central section insertion space insertable into the vertical support axis constituting the unwinding mechanism for unwinding said coiled carrying article is formed in the central section of said pallet main body, the carrying article loading pallet can be inserted into the vertical support axis of the unwinding mechanism from above through the insertion space and the coiled carrying article as well as the pallet can be set to the unwinding mechanism. As a result, it is possible to support the coiled carrying article by the unwinding mechanism without damaging the article and to conduct a predetermined processing to a wire rod, a plate material or the like obtained by unwinding the coiled carrying article.

Further, if said pallet main body includes a leg section which is provided below the pallet main body and which can land on the floor, it is possible to provide a pallet which can be easily transported.

Further, if the lower insertion space, into which transport means for floating the pallet main body from the floor and transporting the pallet can be inserted, is formed below said pallet main body, it is possible to easily transport the pallet while floating the pallet main body from the floor by the transport means inserted into the insertion space.

Further, if said stack support means includes the protrusion prevention section preventing said coiled carrying article mounted on said mount section from being protruded laterally, it is possible to ensure preventing the coiled carrying article mounted on the mount section from being protruded laterally.

Further, if said stack support means includes the upper end receiving section and the lower end engagement section, said upper end receiving section of said lower pallet and said lower end engagement section of said upper pallet are engaged with each other, and the lower pallet and the upper pallet form a pair among the plurality of said pallets in stacking the plurality of said pallets, then it is possible to vertically stack and support arbitrary pallets among a plurality of prepared pallets in arbitrary order.

If said stack support means consists of a plurality of stack base materials attached to the pallet main body and extending vertically, it is possible to provide a pallet lighter in weight and higher in strength and to further improve the loading efficiency of the transport receptacle.

If said mount section consists of a plurality of mount base materials arranged in a horizontal plane, it is possible to provide a pallet lighter in weight and higher in strength and to further improve the loading efficiency of the transport receptacle.

If said abutment section is shaped into a polygonal ring form, it is possible to provide a pallet lighter in weight and higher in strength and to further improve the loading efficiency of the transport receptacle.

If said transport receptacle is a container, it is possible to carry and transport the coiled carrying article more suitably.

If said coiled carrying article is formed by winding a wire rod or a plate material into a coil, it is possible to carry and transport such a coiled carrying article more suitably.

If the diameter of said coiled carrying article is set larger than half the width of said transport receptacle, and the axial length of the coiled carrying article is set smaller than half the height of said transport receptacle, then it is possible to ensure stacking the coiled carrying articles and to arrange the plural coiled carrying articles in two rows in a zigzag fashion if the transport receptacle is seen from a plane.

According to the loading structure for loading the coiled carrying article on the pallet of the present invention, the coiled carrying article is loaded on a pallet while the axial direction of the article is set vertically. If such loading structures (carrying article loading pallets) are vertically stacked and supported in plural, a plurality of coiled carrying articles are stacked vertically. Further, if such a stacking structure is contained in the transport receptacle, a plurality of coiled carrying articles are arranged in a zigzag fashion if the transport receptacle is seen from a plane. As a result, it is possible to easily, deliberately, efficiently carry the coiled carrying article to the transport receptacle without damaging the article, and to transport the article while holding down transport cost. It is also possible to improve space efficiency for the storage of the coiled carrying article.

According to the stacking structure for stacking a plurality of carrying article loading pallets of the present invention, a plurality of loading structures are stacked and supported vertically and a plurality of coiled carrying articles are stacked vertically. If such stacking structures (stacked carrying article loading pallets) are contained in the transport receptacle, a plurality of coiled carrying articles are arranged in a zigzag fashion if the transport receptacle is seen from a plane. As a result, it is possible to easily, deliberately, efficiently carry the coiled carrying articles to the transport receptacle without damaging the articles, and to transport the articles while holding down transport cost. It is also possible to improve space efficiency for the storage of the coiled carrying articles.

According to the containing structure for containing stacked carrying article loading pallets into a transport receptacle of the present invention, the stacking structure is contained in the transport receptacle and a plurality of coiled carrying articles are arranged in a zigzag fashion if the transport receptacle is seen from a plane. As a result, it is possible to easily, deliberately, efficiently carry the coiled carrying articles to the transport receptacle without damaging the articles, and to transport the articles while holding down transport cost. It is also possible to improve space efficiency for the storage of the coiled carrying articles.

If the containing structure for containing stacked carrying article loading pallets into the transport receptacle includes a single carrying article loading pallet which is contained in said transport receptacle and on which another pallet is not stacked, it is possible to mount a mixture of different types of coiled carrying articles different in material, size and the like into the transport receptacle, and to deal with the transport of small quantities of varied types of articles. As a result, it is possible to minimize the number of stocks of the coiled carrying articles and the storage space of a transport destination.

According to the method for transporting stacked carrying article loading pallets to the transport receptacle of the present invention, the stacking structure is introduced into and discharged from the transport receptacle. As a result, it is possible to easily, deliberately, efficiently carry the coiled carrying articles to the transport receptacle without damaging the articles, and to transport the articles while holding down transport cost. It is also possible to improve space efficiency for the storage of the coiled carrying articles.

According to the method for transporting the coiled carrying article of the present invention, the stacking structure is introduced into the transport receptacle, the transport receptacle containing a predetermined number of the coiled carrying articles is transported to a destination, and the stacking structure is discharged from the transport receptacle transported to the destination. As a result, it is possible to easily, deliberately, efficiently carry the coiled carrying articles to the transport receptacle without damaging the articles, and to transport the articles while holding down transport cost. It is also possible to improve space efficiency for the storage of the coiled carrying articles.

According to the method for using the carrying article loading pallet of the present invention, the loading structure is inserted from above into the vertical support axis which constitutes the unwinding mechanism and set to the unwinding mechanism. It is, therefore, possible to set and support the coiled carrying article together with the pallet by the unwinding mechanism. As a result, it is possible to support the coiled carrying article by the unwinding mechanism without damaging the article, and to conduct a predetermined processing to the wire rod, plate material or the like obtained by unwinding the coiled carrying article.

### BRIEF DESCRIPTION OF THE DRAWINGS

FIG. 1 is a plan view of a coiled carrying article pallet according to the present invention;

FIG. 2 is a view seen from an arrow II side of FIG. 1;

FIG. 3 is a perspective view of the pallet;

FIG. 4 is a perspective view of important sections of the pallet when the pallet is seen from below;

FIG. 5 is a perspective view for explaining the supporting form of a stack support means;

FIG. 6 is a perspective view showing a state in which reinforcement members are attached to the pallet;

FIG. 7 is a perspective view showing a state in which pallets are stacked;

FIG. 8 is an explanatory view for explaining a pallet stacking function;

FIG. 9 is an explanatory view for explaining the function of containing carrying articles into a container;

FIG. 10 is an explanatory view for explaining the function of containing carrying articles into a container;

FIG. 11 is an explanatory view for explaining the form of containing carrying articles into a container;

FIG. 12 is an explanatory view for explaining the form of containing carrying articles into a container;

FIGS. 13A and 13B are explanatory views for explaining other forms of containing carrying articles into a container, wherein FIG. 13A shows the form of containing a non-stacked pallet as well as stacks of two pallets, and FIG. 13B shows the form of containing a stack of four pallets as well as stacks of two pallets;

FIGS. 14A and 14B are explanatory views for explaining the form of using the carrying article loading pallet, wherein FIG. 14A shows a state just before the carrying article loading pallet is inserted into a vertical support axis from above, and FIG. 14B shows a state of setting and supporting the carrying article loading pallet to and by an unwinding mechanism; and

FIG. 15 is an explanatory view for explaining the other form of the stack support means.

### DETAILED DESCRIPTION OF THE INVENTION

The present invention will be described hereinafter in detail.

### Pallet

A pallet for a coiled carrying article according to the present invention consists of a pallet main body and a stack support means to be described later. This pallet can include a loading means for loading a carrying article (e.g., a flat carrying article) other than the coiled carrying article.

As long as a mount section and an abutment section are provided, the structure, form, material and the like of the above “pallet main body” are not limited to specific ones. This pallet main body normally includes a leg section provided below the pallet main body and capable of landing on the floor. This leg section can be formed out of, for example, one or a plurality of leg base materials (e.g., a pipe material or pipe materials, a rod material or rod materials, a block material or block materials, or a plate material or plate materials).

Further, a lower insertion space into which the transport means can be inserted can be formed below the above pallet main body. This lower insertion space can be a space which has at least one open side of four sides of front, rear, left and right sides of the pallet main body. With a view of enabling improving the degree of freedom for the transport of the transport means, it is preferable that the four sides of the front, rear, left and right sides of the pallet main body in the lower insertion space are all opened.

The type, structure and the like of the above transport means are not limited to specific ones as long as the transport means can transport the pallet while being inserted into the lower open space and floating the pallet main body from the floor. For example, the transport means can be a forklift, an air floating type transport device, a sliding type transport device, a suspended transport device or the like.

Further, a central section insertion space insertable into the vertical support axis constituting, for example, an unwinding mechanism can be formed in the central section of the above pallet main body. This central section insertion space is normally a space which penetrates vertically. While the shape of this central section insertion space is not limited to a specific shape, it can be, for example, a circular space which is slightly larger in diameter than the vertical support axis.

The above lower insertion space and the central insertion space can be used for inserting a fixing member (e.g., a band) for fixing the coiled carrying article to the pallet and for the other arbitrary purposes.

If the coiled carrying article is not loaded, the pallet main bodies of other pallets can be stacked on the upper and lower surfaces of the above pallet main body, respectively. By doing so, it is possible to return many empty pallets while stacking them and to decrease a space for storing empty pallets.

The structure, purpose and the like of the above “unwinding mechanism” are not limited to specific ones as long as the mechanism can support and unwind the coiled carrying article while the axial direction of the article is set vertically. This unwinding mechanism is normally provided on the uppermost stream of a predetermined processing line (e.g., a drawing line). In addition, the support axis which constitutes this unwinding mechanism can be, for example, an inclinable unwinding mechanism which can be freely inclined between a horizontal position and a vertical position or a fixed unwinding mechanism which cannot be inclined.

In the above processing line, a predetermined processing is conducted to the wire rod obtained by unwinding the coiled carrying article to thereby manufacture the axial member (e.g., a driving axis) of an electronic device (e.g., a printer or a computer). With a view of ensuring rust proof and the like, the axial member of such an electronic device is preferably made of stainless steel.

The structure, form, material and the like of the above “mount section” are not limited to specific ones as long as the mount section can mount the coiled carrying article while setting the axial direction of the article vertically. This mount section is normally provided above the above pallet main body. In addition, this mount section can be formed out of one mount member (e.g., a plate member) almost equal in shape to the axial end face of the coiled carrying article. With a view of enabling providing a pallet lighter in weight and higher in strength, this mount section preferably consists of a plurality of mount base materials (e.g., pipes, rod materials, block materials or plate materials) that are arranged in the horizontal plane equal in height. In addition, this mount section can include an elastic member which supports the axial end face side of the coiled carrying article. By providing the elastic member, it is possible to ensure mounting and supporting the coiled carrying article without damaging the article.

The structure, form, material and the like of the above “abutment section” are not limited to specific ones as long as the section is provided on the outer peripheral side of the mount section. This abutment section can normally abut on the inner wall of the transport receptacle and the abutment section of the other pallet. By allowing the abutment sections of the adjacent pallets among the plural pallets contained in the transport receptacle to abut each other, a plurality of coiled carrying articles loaded on a plurality of pallets are arranged in a zigzag fashion if the transport receptacle is seen from a plane. Besides, this abutment section can be shaped into, for example, a polygonal ring form (preferably a regular octagonal ring form) by one or a plurality of abutment base materials (e.g., a pipe material or pipe materials, a rod material or rod materials, a block material or block materials, or a plate material or plate materials). This abutment section can include a detachably attached spacer member. By providing the spacer member, it is possible to make fine adjustments of the pitch of the adjacent coiled carrying articles contained in the transport receptacle.

The above “arranged in a zigzag fashion” means a state in which the coiled carrying articles are arranged in a plurality of rows and the pitches of the adjacent rows are staggered in phase in a row direction.

The above pallet main body can include an abutment section which is in the form of a regular octagonal ring and which is formed by forming a plurality of abutment base materials into a frame, a mount section consisting of a plurality of mount base materials the proximal ends of which are attached to the abutment section and which extend toward the center, and a leg section consisting of a plurality of leg base materials the proximal ends of which are attached to the abutment section and which extend downward. By providing these sections, it is possible to provide a pallet lighter in weight and higher in strength.

The structure, form, material and the like of the above “stack support means” are not limited to specific ones as long as the means is provided on the pallet main body and stacks and supports the other pallets vertically. This stack support means can consist of, for example, one or a plurality of stack base materials (e.g., a pipe material or pipe materials, a rod material or rod materials, a block material or block materials, or a plate material or plate materials) which are attached to the pallet main body and which extend vertically. The base materials can be, for example, also arranged on the inner peripheral side and/or the outer peripheral side of the above mount section. This stack support means can include, for example, an upper receiving section (e.g., a convex section, a concave section or the like) and a lower engagement section (e.g., a concave section, a convex section or the like). The upper end receiving section of the lower pallet and the lower engagement section of the upper pallet, which pallets form a pair, among the plural pallets which are stacked can be engaged with each other (preferably engaged vertically detachably). This stack support means can include, for example, a coupling member (e.g., a pipe material, a rod material, a block material, or a plate material) which couples the upper ends of the above plural stack base materials. By providing the coupling member, it is possible to provide a pallet lighter in weight and higher in strength. Further, this stack support means can include a hook section which is provided on the upper end sides of the above plural stack base materials and which suspend and support them using a suspension transport means (e.g., a crane).

The above stack support means can include a protrusion prevention section which prevents the coiled carrying article mounted on the above mount section from being protruded laterally. This protrusion prevention section can abut, for example, on the inner peripheral side and/or the outer peripheral side of the coiled carrying article. In addition, this protrusion prevention section can consist of, for example, an elastic material. By providing this section, it is possible to ensure preventing the coiled carrying article from being protruded laterally without damaging the article. The above stack support means can include, for example, a reinforcement member which is detachably attached to the above pallet main body. This reinforcement member can include, for example, a vertical reinforcement base material arranged on the outer peripheral side of the mount section of the pallet main body and a horizontal reinforcement base material extending from the upper end side of this vertical reinforcement base material toward the center and detachably attached to the upper end sides of the above stack base materials. By so constituting, it is possible to efficiently distribute load exerted during stacking and to provide a pallet lighter in weight and higher in strength. The vertical reinforcement base material and the horizontal reinforcement base material can be made of, for example, pipe materials, rod materials, block materials, plate materials and the like. The height of the above stack support means, for example, can be adjusted. By so constituting, it is possible to adjust the height position of the stack support means according to the axial length of the coiled carrying article to be loaded and to improve the loading efficiency of the transport receptacle. Further, this stack support means can also serve as the above-described leg section, the mount section, the abutment section or the like.

The material, size, purpose and the like of the above “coiled carrying article” are not limited to specific ones as long as the article is a cylindrical or columnar product. This coiled carrying article can be formed by, for example, winding a wire rod or a plate material into a coil. The wire rod or plate materials can be, for example, free cutting steel, aluminum, stainless steel, synthetic resin, fiber or pulp. The diameter of this coiled carrying article can be set larger than half the width of the transport receptacle and the axial length thereof can be set smaller than half the height of the transport receptacle.

The structure, form, material and the like of the above “transport receptacle” are not limited to specific ones as long as the container can contain a plurality of pallets. This transport receptacle can be, for example, a container, a truck or a freight which includes a receptacle like a container (i.e., a container-like receptacle which is fixed onto the chassis of a truck or a freight) or the like. The above container can be exemplified by, for example, a special container such as an open-top container or a flat container. However it is preferable to employ a dry container (preferably, a 40-feet container) for which a higher holding number is ensured, which is less expensive, easier to secure and more excellent in airtightness than these special containers.

### Carrying Article Loading Pallet

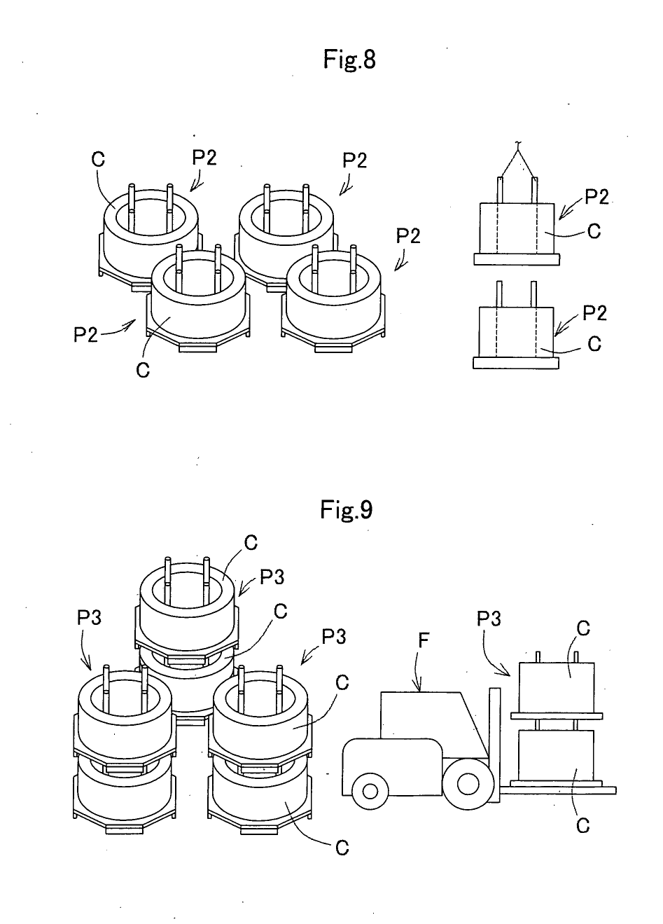

A loading structure (indicated as a carrying article loading pallet P2 in FIG. 8) for loading a coiled carrying article on a pallet according to the present invention is constituted to load the coiled carrying article on the above pallet while the axial direction of the article is set vertically. This carrying article loading pallet can be handled at, for example, a coiled carrying article manufacturing position, a distribution position, a processing position or the like.

Methods for loading the coiled carrying article on the pallet involve, for example, (1) a method for loading the coiled carrying article, which is suspended and transported by a suspension transport means (e.g., a crane), on the pallet, (2) a method for loading the coiled carrying article on the pallet by positioning the coiled carrying article lifted and transported by the above transport means (e.g., a forklift) to the pallet supported with the axial direction thereof set laterally, and inverting the pallet as well as the coiled carrying article by an inverter so that the axial directions become vertical.

### Stacked Carrying Article Loading Pallets

The stacking structure of the carrying article loading pallet (indicated as a stacked carrying article loading pallets P3 in FIG. 9) is constituted so that the above carrying article loading pallets are vertically stacked. The number of stacked carrying article loading pallets is not limited to a specific one. In addition, this stacked carrying article loading pallets can be handled at, for example, a coiled carrying article manufacturing position, a distribution position, a processing position or the like.

Methods for stacking the carrying article loading pallets involve, for example, (1) a method for stacking the carrying article loading pallets by suspension transport by a suspension transport means (e.g., a crane), and (2) a method for stacking the carrying article loading pallets by lifting transport by the above transport means (e.g., a forklift).

### Containing Structure

A containing structure for containing the stacked carrying article loading pallet in the transport receptacle according to the present invention is constituted to contain one or a plurality of the above stacked carrying article loading pallets in the above transport receptacle. The plural coiled carrying articles contained in this transport receptacle are arranged in a zigzag fashion if the transport receptacle is seen from a plane. The number of the coiled carrying articles contained in this containing structure, the number of rows of the zigzag arrangement and the like are not limited to specific ones.

Further, this containing structure can contain not only the above stacked carrying article loading pallets but also one or a plurality of carrying article loading pallets P4 (see FIG. 13A) on which the other pallet is not stacked. By so constituting, it is possible to contain a mixture of coiled carrying articles different in material, size and the like in one transport receptacle. Compared with the conventional structure of containing the coiled carrying articles equal in material, size and the like in each container, this structure is suitable for the production of small quantities of articles of varied types. Besides, this containing structure can be transported by transport means (e.g., a ship, a truck or a freight) between the manufacturing positions, the distribution positions, the processing positions and the like for the coiled carrying articles.

### Method for Transporting Carrying Article Loading Pallet to Transport Receptacle

A method for transporting stacked coiled carrying article loading pallets to a transport receptacle according to the present invention is characterized by including: introducing the above stacked carrying article loading pallets into the above transport receptacle by the above transport means (e.g. a forklift) or discharging the stacked carrying article loading pallets from the above transport receptacle by transport means. While this transport method is normally executed at the coiled carrying article distribution position, it can be also executed at the manufacturing position, processing position or the like. As other transport methods, the following method may be executed, for example. The above carrying article loading pallets are sequentially introduced into the transport receptacle and the pallets are stacked in this transport receptacle.

### Method for Transporting Coiled Carrying Article

A method for transporting a coiled carrying article according to the present invention is characterized by including: an introducing step of introducing the above stacked carrying article loading pallets into the above transport receptacle; a transport step of transporting (by, for example, marine transport) the transport receptacle that contains a predetermined number of the above coiled carrying articles in the introducing step to the other distribution position (a destination); and a discharging step of discharging the stacked carrying article loading pallets from the transport receptacle at the other distribution position. In this transport method, a freight distribution management system, a pallet management system (see Japanese Patent Application No. 2002-281822) and the other systems for keeping the stock of the spot (transmission end) appropriately can be suitably employed.

### Method for Using Carrying Article Loading Pallet

A method for using the carrying article loading pallet according to the present invention includes inserting the above carrying article loading pallet into the vertical support axis of the unwinding mechanism from above and supporting a wire rod or a plate material so as to be able to be unwound.

The methods for using the above pallet involve, for example, a method including setting and supporting the above pallet to and by a winding device for winding the wire rod or the plate material and winding the wire rod or the plate material on this pallet. By doing so, it is possible to handle the carrying article loading pallet at the coiled carrying article manufacturing position (manufacturer). As a result, it is possible to eliminate the direct handling of the coiled carrying articles during the distribution from this manufacturing position to the processing position, and to minimize the damage of the coiled carrying articles.

### Embodiment

The present invention will be described more concretely based on an embodiment with reference to the drawings.

In this embodiment, a container A (see FIG. 11) which is normally referred to as “dry container of 40 feet” is employed as the container. The inside dimensions of the container A are set to have a length of about 12000 to 12100 mm, a width of about 2300 to 2400 mm, and a height of about 2300 to 2400 mm. In this embodiment, as the coiled carrying article, a coiled carrying article C (which will be also referred simply as “carrying article C”) formed by winding a wire rod made of stainless steel with a predetermined number of turns and having a weight of about it is employed. The diameter D of this carrying article C (about 1200 to 1300 mm) is set to be not less than half the width W of the container A and the axial length thereof (about 650 mm) is set to be not more than half the height of the container A.

(1) Configuration of Coiled Carrying Article Pallet

The pallet P1 in this embodiment is employed to contain the carrying article C in the above container A and to transport the article. This iron steel pallet P1 consists of a pallet main body 1 which consists of an abutment section 2, a mount section 3 and a leg section 4, and a stack support means 5 provided on this pallet main body 1.

The above abutment section 2 is formed into a regular octagonal ring by welding a plurality of (eight in the drawings) abutment base materials 7 (e.g., square pipes) equal in outside dimension. A ring material 8 (e.g., a plate material) is provided on the inner periphery side of the abutment section 2, and a plurality of (eight in the drawings) mount base materials 9 are welded at a predetermined pitch along the circumferential direction between this abutment section 2 and the upper surface of the ring material 8. An elastic member 10 made of rubber is laid on the upper surfaces of the mount members 9, thus constituting the above mount section 3. This mount section 3 is constituted to be able to mount the axial end face side of the carrying article C. The abutment sections 2 are constituted so that the abutment sections 2 of the adjacent pallets P1 abut on each other when containing a predetermined number of (twelve) pallets P1 in the container A and so that the predetermined pallets P1 and the carrying articles C loaded on the pallets P1 can be arranged in a zigzag fashion if the container A is seen from a plane (see FIG. 11).

Further, a plurality of (eight in the drawings) leg base materials 11 (e.g., square pipe materials) extending downward are provided at coupling portions of the above abutment base materials 7, respectively. A plurality of (four in the drawings) restriction base materials 12 which restrict the insertion of the pawls N of a forklift and which extend horizontally to correspond to the alternate abutment base materials 7 are welded between these leg base materials 11. The leg base materials 11 and the restriction base materials 12 constitute the leg section 4 which lands on the floor.

Below the above pallet main body 1, a lower insertion space 14 the four sides of front, rear, left and right sides of which are opened and into which the pawls N of the forklift can be inserted from the four sides is formed. A central section insertion space 15 which is larger in diameter than a support axis which constitute an unwinding mechanism to be described later is formed in the central section of the pallet main body 1.

Since the above lower insertion space 14 is a space having the four sides of front, rear, left and right sides opened, the degree of freedom for transport by the forklift is increased. Further, the restriction base materials 12 can prevent the invasion of the forklift from an incorrect direction.

The above stack support means 5 includes a plurality of (four in the drawings) stack base materials 17 (e.g., round pipe materials) which are welded to the inner periphery of the ring material 8 and which extend vertically. The upper ends of the stack base materials 17 are coupled to one another by welding a coupling ring material 18 (e.g., a round pipe material) to the materials 17. Further, hook members 19 (e.g., round rod materials) suspending and supporting the articles using the suspension transport means (e.g., a crane) are welded to the upper ends of the respective stack base materials 17. Besides, elastic pipe materials 20 made of synthetic resin on which the inner periphery of the carrying article C mounted on the mount section 3 can abut, are attached to the outer peripheries of the respective stack base materials 17.

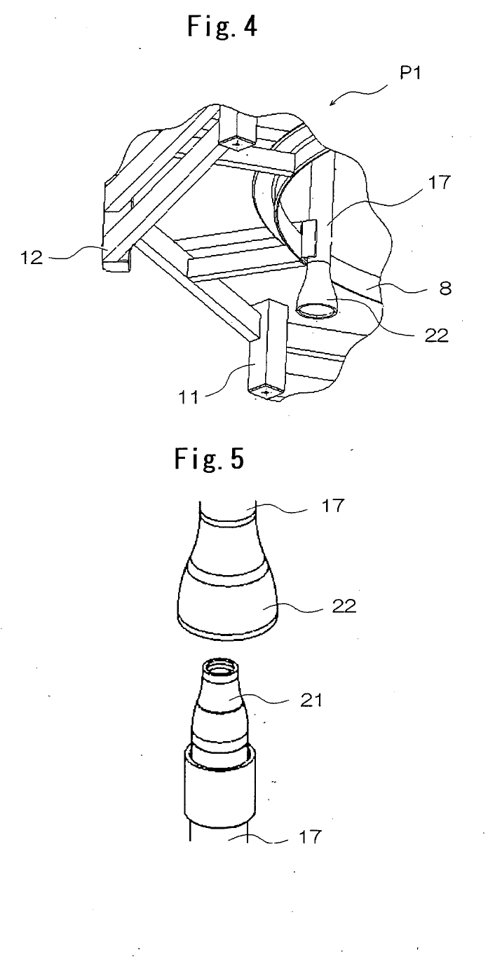

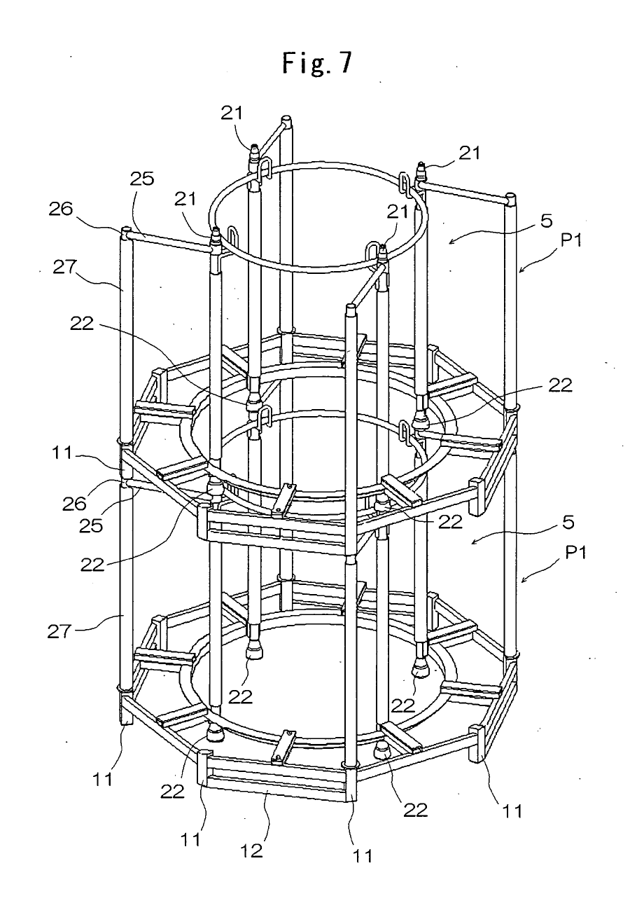

As shown in FIGS. 4 and 5, each stack base material 17 is provided with a convex section 21 protruded and tapered toward the upper direction on the upper end of the stack base material 17 and a stack concave section 22 opened while the diameter of the section 22 increases toward the lower direction on the lower end of the stack base material 17. If a plurality of pallets P1 are stacked, the stack convex section 21 of the lower pallet P1 is engaged with the stack concave section 22 of the upper pallet P1 while they are freely detachable vertically (see FIG. 7).

The lower end of the above stack concave portion 22 is set so as to be able to land on the floor together with the above leg base materials 11 and the restriction base materials 12.

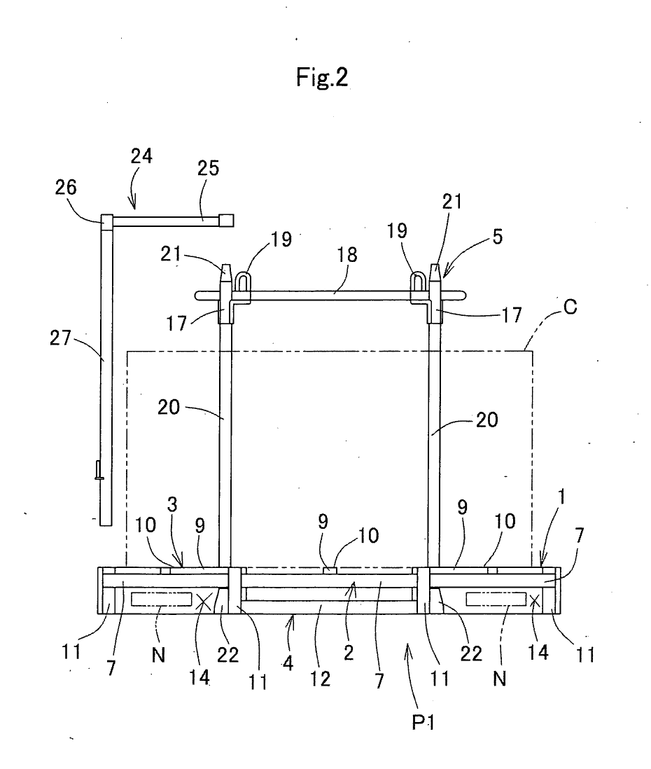

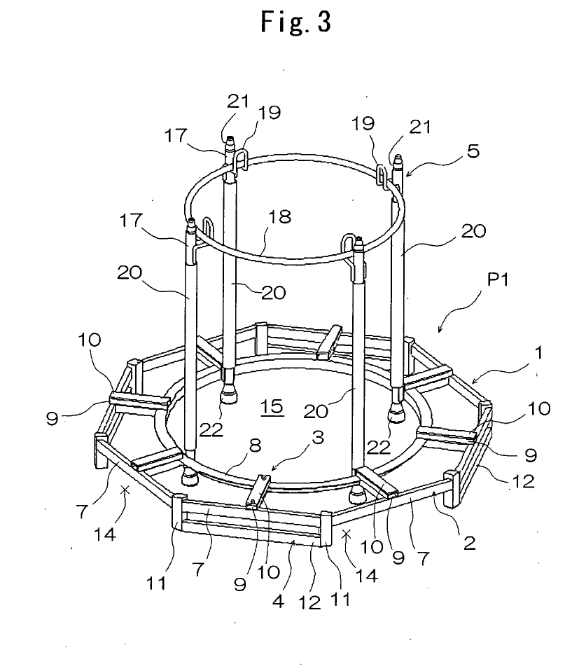

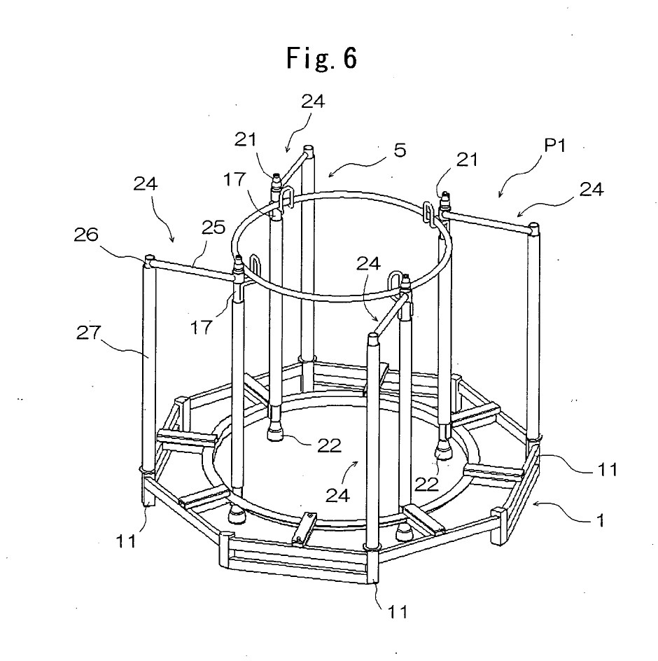

Further, as shown in FIGS. 2 and 6, the stack support means 5 includes a plurality of (four in FIG. 6) reinforcement members 24 detachably attached to the pallet main body 1. Each of the reinforcement members 24 includes a horizontal reinforcement base material 25 (e.g., a round pipe material) having one end coupled to the upper end of each stack base material 17 to be insertable. The upper end of a vertical reinforcement base material 26 (e.g., a round pipe material) which extends vertically is welded to the other end of this horizontal reinforcement base material 25. Further, an elastic pipe 27 made of synthetic resin and on which the outer peripheral side of the carrying article C mounted on the above mount section 3 can abut, is attached to the outer periphery of this vertical reinforcement base material 26. When stacking the pallets P1, the lower end face of the leg base material 11 of the upper pallet P1 is mounted on the upper end face of the vertical reinforcement base material 26 of the lower pallet P1. Therefore, the respective reinforcement members 24 can appropriately distribute the load on the lower pallet P1 during stacking (see FIG. 7).

(2) Function of Transporting Stacked Carrying Article Loading Pallets to Container

Next, the function of transporting the coiled carrying article C into the container A will be described.

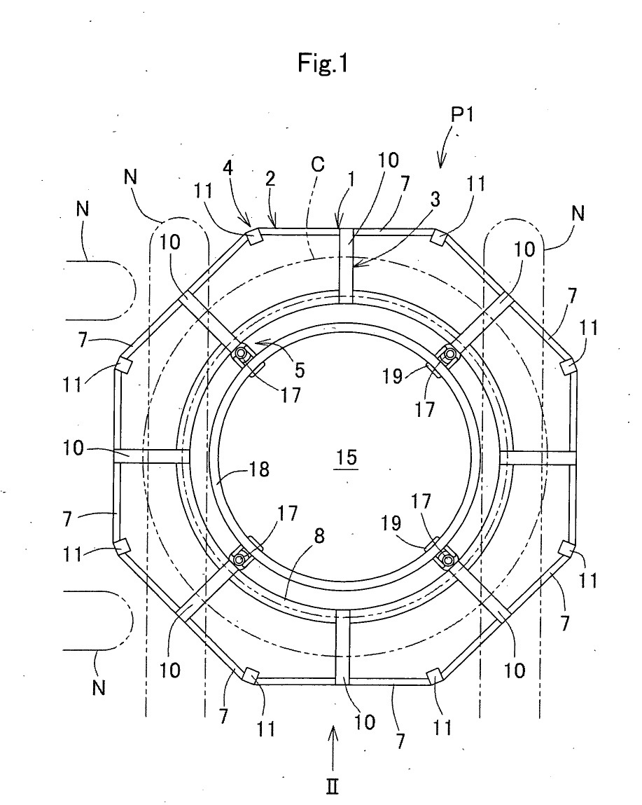

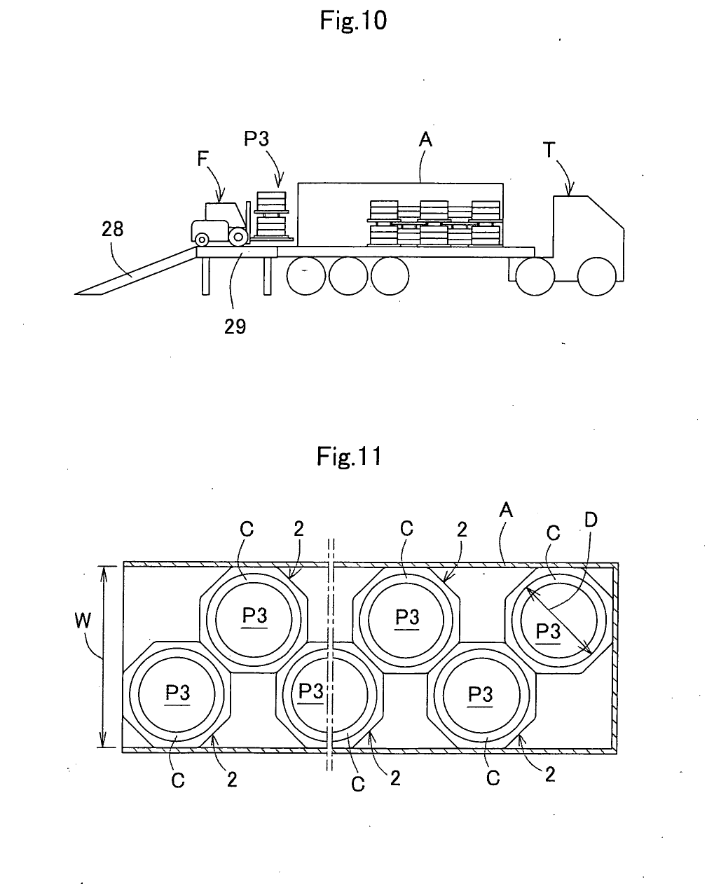

First, the axial direction of the carrying article C is set vertically by a crane or the like, the carrying article C is mounted on the mount section 3 of the pallet P1 and use the pallet P1 as the carrying article loading pallet P2 (see FIG. 8). A plurality of carrying article loading pallets P2 are prepared, each pair of stacked carrying article loading pallets P2 are stacked as an upper pallet and a lower pallet, respectively, by a crane or the like, thus providing stacks of carrying article loading pallets P3 (see FIG. 9). Next, a predetermined number of (e.g., twelve) stacked carrying article loading pallets P3 are prepared. As shown in FIG. 10, the stacked carrying article loading pallets P3 are sequentially introduced into the container A from the depth of the container A through a slope 28 and a stage 29. During this transport, the pawls N of the forklift F are inserted into the lower insertion space 14 of the lower pallet P1 which constitutes the stacked the carrying article loading pallets P3 and the stacked the carrying article loading pallets P3 are transported while being floated from the floor (see FIGS. 1 and 2). Thereafter, the container A in which twelve stacked carrying article loading pallets P3 are finally contained is transported by land using a container truck T or the like or by sea using a container ship (not shown).

The process of introducing the carrying load C into the container A has been described above in detail. A discharge operation for discharging the carrying article C from the container A can be conducted by taking opposite procedures to those for the above-stated introducing operation. In the above embodiment, the carrying article is carried into the container mounted on the truck T using the slope 28 and the stage 29. However, the present invention is not limited thereto. For example, the carrying article may be carried into the container mounted on the truck through a platform or into the container (floor type container) moved from the load-carrying platform of the truck to the floor by an appropriate moving means (e.g., the side lifter of the truck, a ceiling crane, a large-sized forklift or the like).

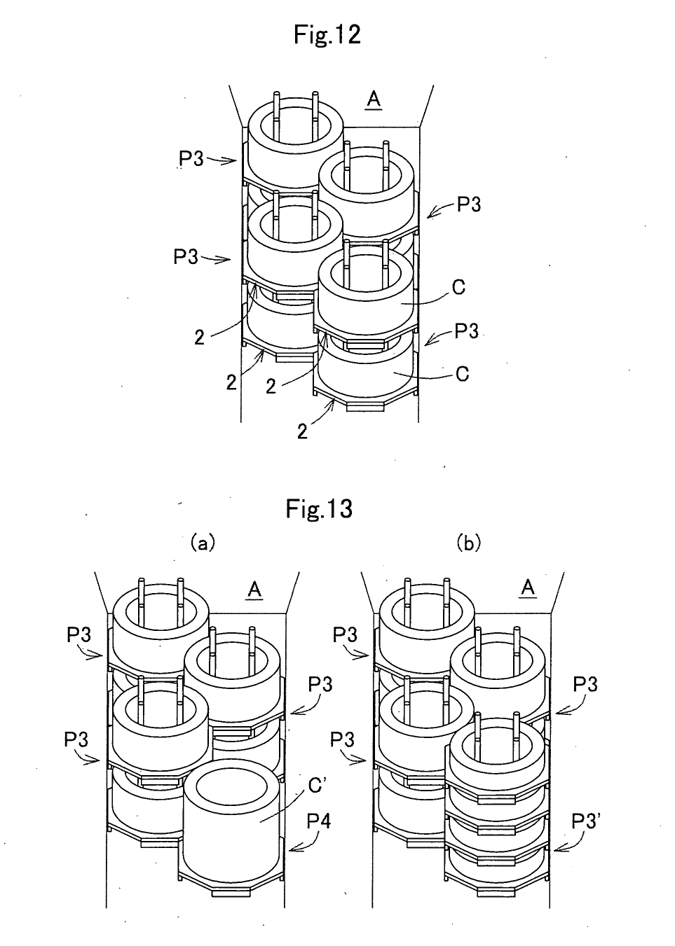

While a predetermined number of stacked carrying article loading pallets P3 is contained in the container A, the carrying articles C are stacked on and supported by vertically at predetermined intervals on each stacked carrying article loading pallet P3 as shown in FIGS. 11 and 12. In addition, the abutment section 2 of each stacked carrying article loading pallets P3 abut on the inner wall (sidewall or front or rear wall) of the container A and the abutment sections 3 of the upper and lower pallets P1 which constitute the adjacent stacked carrying article loading pallets P3 abut on each other, whereby the carrying articles C loaded on the respective stacked carrying article loading pallets P1 are arranged in a zigzag fashion if the container A is seen from a plane.

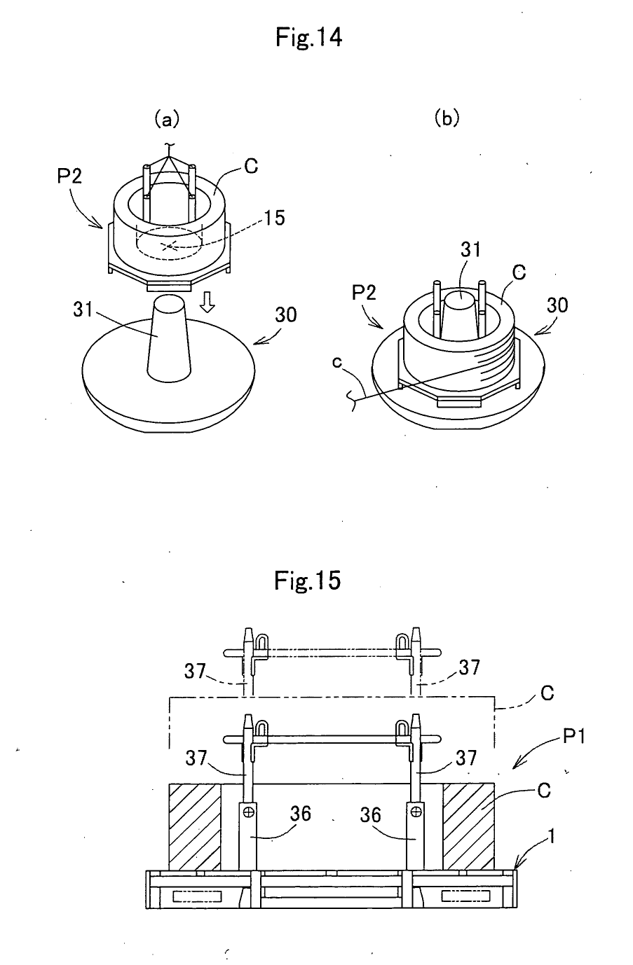

Next, a method for using the carrying article loading pallet P2 will be described. As shown in FIGS. 14A and 14B, at the coiled carrying article processing position, the unwinding mechanism 30 for unwinding the carrying article C is provided on the uppermost stream of a predetermined processing line (e.g., a printer driving axis drawing line). The central section insertion space 15 of the carrying article loading pallet P2 is inserted from above into the fixed vertical support axis 31 which constitutes this unwinding mechanism 30, and the carrying article loading pallet P2 is set to and supported by this unwinding mechanism 30. From this state, a wire rod c is unwound from the carrying article C and a predetermined processing is conducted to this wire rod c.

(3) Advantages of Embodiment

As stated so far, according to this embodiment, it is possible to transport the coiled carrying article C by the container using the pallet P1. As a result, it is possible, for example, to protect the carrying article C by the container A, to shorten loading time and transport time, to save storage spaces before and after the transport (the spot and the destination), to facilitate stock management. In addition, since the carrying article C is carried into the container A using the pallet P1, the pawls N of the forklift do not directly contact with the carrying article C and it is possible to prevent the carrying article C from being damaged as much as possible. In addition, the abutment section 2 is provided on the outer periphery of the mount section 3 which constitutes the pallet main body 1. Therefore, even if an operator erroneously performs operation when carrying the carrying article C, the abutment section 3 abuts on the inner wall or the floor of the container A. It is thereby possible to prevent the carrying article C from being directly struck against the inner wall or the floor of the container A, and to prevent the carrying article C from being damaged as much as possible. Besides, it is possible to ensure carrying all the carrying targets to the container and to deliberately carry out the carrying operation for carrying the carrying article C to the container A.

In the conventional coiled carrying article transport without using the pallet, the frequency of carrying the carrying article by directly contacting the carrying means (a forklift, a crane or the like) with the carrying article (handling frequency) is eight. Namely, the carrying means directly contacts with the carrying article and carries the article during \textcircled{1} packaging at the coiled carrying article manufacturing position (the manufacturer or the like), \textcircled{2} moving and mounting the article to the truck or the like while keeping putting the article horizontally, \textcircled{3} vanning at the distribution position (the vanning center or the like), \textcircled{4} de-vanning at the distribution position of the transport destination, \textcircled{5} moving and mounting the article to the truck or the like while putting the article horizontally, \textcircled{6} de-vanning at the processing position (the processing manufacturer or the like), \textcircled{7} storage, \textcircled{8} loading of the article on the dedicated pallet, and the like. As a result, the probability of damaging the carrying article during the distribution is high. According to the embodiment of the present invention, by contrast, the frequency of directly contacting the carrying means with the carrying article is only two; \textcircled{1} moving and mounting the article to the truck or the like at the manufacturing position while putting the article horizontally, \textcircled{2} loading of the article on the pallet P1 at the distribution position, and the like. It is thereby possible to almost eliminate the damage of the carrying article during the distribution. Further, if the wire rod is wound using the pallet P1 at the manufacturing position, there is no chance of directly contacting the carrying means with the carrying article, making it possible to completely eliminate the damage of the coiled carrying article during the distribution.

Furthermore, in this embodiment, the carrying article C is mounted on the mount section 3 of the pallet main body 1 while the axial direction of the article C is set vertically. Due to this, it is possible to prevent the carrying means from directly contacting with the carrying article to the container A, to prevent the carrying article C contained in the container A from directly contacting with the inner wall of the container A or the carrying article C of the other pallet P1 and thereby being damaged, and to eliminate a laborious operation for, for example, strictly packaging the carrying article C with a vinyl sheet or the like.

Moreover, in this embodiment, the abutment section 2 and the mount section 3 of the pallet main body 1 enable a plurality of carrying articles C contained in the container with the axial directions thereof set vertically, to be overlapped with one another longitudinally and laterally and arranged in a zigzag fashion. Compared with the conventional art of storing the coiled carrying articles with the axial directions thereof set horizontally, it is possible to improve the loading efficiency of the container A. Besides, the peripheral surfaces of the adjacent carrying articles among the plural carrying articles arranged in a zigzag fashion do not contact with each other and damage each other. Further, the stack support means 5 vertically stacks and supports the pallets P1, and the carrying articles C are stacked vertically at predetermined intervals in each stacked carrying article loading pallet P3 contained in the container A. Due to this, the end faces of the upper and lower carrying articles do not contact with each other and damage each other. It is further possible to extremely improve the loading efficiency for loading the carrying articles C to the container A. For the same reasons stated above, it is possible to greatly improve space efficiency for storing the carrying articles C using the pallet P1 at the coiled carrying article manufacturing position, distribution position, processing position and the like.

In this embodiment, each stack support means 5 includes the stack convex section 21 and the stack concave section 22, so that arbitrary pallets P1 among a plurality of prepared pallets P1 can be easily stacked and supported vertically in arbitrary order.

In this embodiment, the abutment sections 3 of the adjacent pallets P3 in a plurality of stacked carrying article loading pallets P3 contained in the container A, abut on each other to restrict the movement and position the pallets P3 so as not to shift the load. Therefore, it is unnecessary to carry out the operation for fixing and detaching the pallets P3 to and from the container, making it possible to carry out the operation for carrying the carrying articles C easily in short time. In the conventional fixing operation, the carrying articles put horizontally are fixed using lumbers or the like. To prevent dew droplets from adhering to the carrying articles due to the influence of water content of the lumbers, the lumbers as well as the carrying articles are packaged with a vinyl sheet or the like. In this embodiment, by contrast, it is unnecessary to carry out such a laborious fixing operation including complicated measures against dew droplets.

In this embodiment, the stack base material 17 and the vertical reinforcement base material 26 which constitute the stack support means 5 restrict the protrusion of the carrying article C in a lateral direction. Therefore, it is unnecessary to carry out the laborious fixing operation for fixing and positioning the carrying article C to the pallet P1 using a fixing band or the like.

In this embodiment, the elastic pipe materials 20 and 27 are provided on the outer peripheries of the stack base material 17 and the vertical reinforcement base material 26, respectively, and the elastic member 10 is laid on the upper surface of the mount section 3. It is, therefore, possible to prevent the damage of the end face and peripheral surface of the carrying article C mounted on the mount section 3 as much as possible.

In this embodiment, at the coiled carrying article processing position, the carrying article loading pallet P2 is set to and supported by the unwinding mechanism 30. Compared with the conventional art in which the carrying article put horizontally is stood up using the dedicated tool and set to and supported by the unwinding mechanism, it is possible to prevent the carrying article from being damaged as much as possible.

The present invention is not limited to the concrete embodiment stated above but various changes and modifications can be made to the invention within the scope of the invention according to the purposes and usages. Namely, in this embodiment, only a predetermined number of (twelve) stacked carrying article loading pallets P3 are contained in the container A. However, the number of pallets is not limited thereto. For example, as shown in FIG. 13A, non-stacked carrying article loading pallets P4 loading only coiled carrying articles C′ made of free cutting steel and having a weight of about 2t (a diameter of 1200 mm, and an axial length of 1300 mm) as well as the stacked carrying article loading pallets P3 may be contained in the container A. Further, as shown in, for example, FIG. 13B, three or more (four in FIG. 13B) stacked carrying article loading pallet P3′ as well as two stacked carrying article loading pallets P3 may be contained in the container A. By doing so, it is possible to realize the transport of coiled carrying article according to small quantities of varied types of articles. As a result, it is possible to decrease the number of stocks and the storage space of the transport destination.

In this embodiment, the stack support means 5 is constituted by a plurality of stack base materials 17 attached to the ring material and each having a predetermined length. However, the constitution of the stack support means 5 is not limited thereto. For example, as shown in FIG. 15, a pipe member 36 may be attached to the pallet main body 1, a stack base material 37 may be supported in the pipe member 36 to be able to be freely elevated therein, and the stack base material 37 may be positioned and fixed to a desired axial position relative to the pipe member 36 using a fixing tool. By doing so, it is possible to adjust the height position of the stack base material 37 according to the size (axial length) of the coiled carrying article C to be loaded on the pallet, and to further improve loading efficiency for loading the coiled carrying articles into the container A. Besides, a plurality of stack base materials detachable from the pallet main body and having different lengths may be prepared. Among these stack base materials, an appropriate stack base material may be selected according to the size (axial length) of the coiled carrying article C to be loaded, and the selected stack base material may be attached to the pallet main body to constitute the pallet.

In this embodiment, the abutment section 2 in the form of a regular octagonal ring is shown by way of example. However, the form of the abutment section 2 is not limited thereto. For example, the abutment section 2 may be in the form of a plate, a box, a regular dodecagonal ring, an octagonal ring having unequal sides, a circular ring, an elliptic ring, or a polygonal ring.

Further, in this embodiment, the mount section 3 is constituted to be able to load one coiled carrying article C. However, the mount section 3 may be constituted to be able to load two or more coiled carrying articles.

In this embodiment, the containing form of enabling the carrying articles C to be efficiently contained in the container A (arranging the articles C in two rows in a zigzag fashion) while the diameter D of each coiled carrying article C is slightly larger than half the width W of the container A has been described. However, the containing form is not limited thereto. For example, if the diameter of each coiled carrying article is slightly larger than a third of the width of the container, the coiled carrying articles may be arranged in three rows in the container in a zigzag fashion. In that case, the pallet in the central row does not abut on the inner wall of the container and the movement of the pallet is restricted only by abutting on the other pallets.

In this embodiment, the example of using the pallets P1 (P2, P3) equal in size and form has been described. However, the size and form of the pallets are not limited thereto. A combination of plural types of pallets P1 different in size and form may be used. In that case, it is possible to increase the number of thin coiled carrying articles loaded in the container. Even thick coiled carrying articles can be loaded on the pallet without protruding the articles from the pallet. It is thus possible to make good use of appropriate pallets according to the size of a coil and to effectively load the articles in the container. Besides, the pallets can be used for not only the dry container of 40 feet as shown in this embodiment but also a dry container of 20 feet different from 40 feet or the like and for an open top container or the like.

For reference, not the above coiled carrying articles but non-coiled, i.e., cylindrical carrying articles, columnar carrying articles or the like which consist of single formed products may be used. It is also possible to employ one rod-like carrying article, a carrying article assembly obtained by binding rod materials and the like. The forms of the mount sections of the pallets which are used for these cases may be selected arbitrarily as long as the carrying articles to be used can be loaded on the pallets.

What is claimed is:

1. A coiled carrying article pallet contained in a transport receptacle while loading a coiled carrying article, the pallet comprising:
a pallet main body;
a stack support means, provided on the pallet main body, for vertically stacking and supporting another pallet;
a mount section provided on said pallet main body, and capable of mounting an axial end face side of said coiled carrying article; and
an abutment section provided on an outer peripheral side of the mount section, wherein
if a plurality of said pallets are contained in said transport receptacle, said abutment sections of the adjacent pallets among the plurality of said pallets abut on each other, whereby a plurality of said coiled carrying articles loaded on the plurality of said pallets are arranged in a zigzag fashion.

2. A coiled carrying article pallet according to claim 1, wherein
a central section insertion space, insertable into a vertical support axis which constitutes an unwinding mechanism for unwinding said coiled carrying article, is formed in a central section of said pallet main body.

3. A coiled carrying article pallet according to claim 1, wherein
said pallet main body includes a leg section provided below the pallet main body, the leg section capable of landing on a floor.

4. A coiled carrying article pallet according to claim 1, wherein a lower insertion space, into which a transport means for floating the pallet main body from a floor and transporting the pallet can be inserted, is formed below said pallet main body.

5. A coiled carrying article pallet according to claim 1, wherein said stack support means includes a protrusion prevention section preventing said coiled carrying article mounted on said mount section from being protruded laterally.

6. A coiled carrying article pallet according to claim 1, wherein said stack support means includes an upper end receiving section and a lower end engagement section, said upper end receiving section of said lower pallet and said lower end engagement section of said upper pallet are engaged with each other, said lower pallet and said upper pallet forming a pair among the plurality of said pallets in stacking the plurality of said pallets.

7. A coiled carrying article pallet according to claim 1, wherein said stack support means consists of a plurality of stack base materials attached to said pallet main body, and extending vertically.

8. A coiled carrying article pallet according to claim 1, wherein said mount section consists of a plurality of mount base materials arranged in a horizontal plane.

9. A coiled carrying article pallet according to claim 1, wherein said abutment section is shaped into a polygonal ring form.

10. A coiled carrying article pallet according to claim 1, wherein said transport receptacle is a container.

11. A coiled carrying article pallet according to claim 1, wherein said coiled carrying article is formed by winding a wire rod or a plate into a coil.

12. A coiled carrying article pallet according to claim 1, wherein a diameter of said coiled carrying article is set larger than half a width of said transport receptacle, and an axial length of the coiled carrying article is set smaller than half a height of said transport receptacle.

13. A loading structure for loading a coiled carrying article on a pallet, comprising:
the pallet according to claim 1; and
said coiled carrying article loaded on the pallet while an axial direction is oriented to a vertical direction.

14. A stacking structure for stacking a plurality of carrying article loading pallets, wherein a plurality of the loading structures according to claim 13 are stacked vertically.

15. A containing structure for containing a stack of carrying article loading pallets into a transport receptacle comprising: the transport receptacle; and the stacking structure according to claim 14, wherein
a plurality of said coiled carrying articles contained in said transport receptacle are arranged in a zigzag fashion.

16. A containing structure for containing a stack of carrying article loading pallets into a transport receptacle according to claim 15, further comprising a single carrying article loading pallet which is contained in said transport receptacle and on which another pallet is not stacked.

17. A method for transporting a stack of carrying article loading pallets to a transport receptacle, wherein the stacking structure according to claim 14 is transported into said transport receptacle.

18. A method for transporting a coiled carrying article, comprising:
an introducing step of introducing the stacking structure according to claim 14 into said transport receptacle;
a transport step of transporting said transport receptacle containing a predetermined number of said coiled carrying articles in said introducing step to a destination; and
a discharging step of discharging said stacking structure from said transport receptacle transported to the destination in said transport step.

19. A method for using a carrying article loading pallet, wherein the loading structure according to claim 13 is supported by an unwinding mechanism by inserting the loading structure into a vertical support axis constituting the unwinding mechanism from above.
